(19) United States
(12) Patent Application Publication
(10) Pub. No.: US 2012/0125341 A1
(43) Pub. Date: May 24, 2012

(54) FILTERING FACE-PIECE RESPIRATOR HAVING AN OVERMOLDED FACE SEAL

(75) Inventors: Yonas Gebrewold, Woodbury, MN (US); Michael K. Domroese, Woodbury, MN (US); Dean R. Duffy, Woodbury, MN (US); Dwayne D. Daugaard, Hudson, WI (US); Nhat Ha T. Nguyen, Woodbury, MN (US); David M. Blomberg, Lino Lakes, MN (US); Denise A. Barrera, Oakdale, MN (US)

(73) Assignee: 3M Innovative Properties Company

(21) Appl. No.: 12/949,954

(22) Filed: Nov. 19, 2010

(51) Int. Cl. A62B 23/02; B29C 37/00; B29C 65/00

(52) U.S. Cl. 128/206.12; 264/249; 264/138

(57) ABSTRACT

An filtering face-piece respirator that includes a mask body 12 and a harness 14. The mask body includes a support structure 16, filtering structure 18, and a face seal element 40. The face seal element 40 is overmolded onto at least a portion of a perimeter of the support structure of the mask body. The overmolding of the face seal member to the support structure allows the face seal to become firmly secured to the mask body at its perimeter.

### BACKGROUND

Respirators are worn in the workplace for at least one of two common purposes: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that are harmful to the wearer—for example, in an auto body shop. In the second situation, the respirator is worn in an environment where there is risk of contamination to other persons or things—for example, in an operating room or in a clean room.

Some respirators are categorized as being “filtering face-piece respirators” because the mask body itself functions as the filtering mechanism. Unlike respirators that use rubber or elastomeric mask bodies in conjunction with attachable filter cartridges (see, e.g., U.S. Pat. RE39,493 to Yuschak et al.) or insert-molded filter elements (see, e.g., U.S. Pat. No. 4,790,306 to Braun), filtering face-piece respirators are fashioned to have the filter media comprise much of the whole mask body surface so that there is no need for installing or replacing a filter cartridge. As such, filtering face-piece respirators are relatively light in weight, easy to use, and are disposable.

Filtering face-piece respirators generally fall into one of two categories: fold-flat respirators and shaped respirators. Fold-flat respirators are stored flat but can be opened into a cup-shaped configuration for use. Examples of fold-flat filtering face-piece respirators are shown in U.S. Pat. Nos. 6,568,392 and 6,484,722 to Bostock et al. and 6,394,090 to Chen. Shaped respirators, in contrast, are more-or-less permanently formed into a desired face-fitting configuration and generally retain that configuration during storage and use. Shaped respirators include molded shaping layers that are often made of thermally bonded fibers or open-work filamentary meshes. The shaping layers are molded into cup-shaped configurations that support the filtering structure. Examples of shaped respirators are described in the following U.S. Pat. Nos.: 7,131,442 to Kronzer et al, 6,923,182 and 6,041,782 to Angadjivand et al., 4,873,972 to Magidson et al., 4,850,347 to Skov, 4,807,619 to Dyrud et al., 4,536,440 to Berg, and in U.S. Patent Application Publication 2009/0078265A1 to Martin et al.

Filtering face-piece respirators of the kinds described typically comprise several different components that are joined or assembled together to make an integral unit. These components may include exhalation valves, face seals, headbands, nose clips, and the like. As such, filtering face-piece respirators may range from those that are relatively simple in construction to those that are more complicated. Face seal components are regularly added because they provide a comfortable fit between differing contours of a wearer's face and the respirator mask body, as well as to accommodate dynamic changes that might render the seal ineffective, such as when a wearer's face is moving during talking Adhesives and ultrasonic welding are often used to secure a face seal to the mask body. The use of adhesives and ultrasonic welding, however, presents the need for additional processing steps to join the face seal to the mask body. Although face seals also have been joined to the mask body directly through injection molding—see U.S. Pat. No. 4,454,881 to Huber et al.—such securement presents delamination risks during respirator use. Filtering structures that are used in mask bodies often comprise nonwoven fibrous layers, particularly nonwoven webs of meltblown microfibers, which layers tend to be relatively delicate and can become separated from each other when subjected to lateral and torsional forces. The forces that the face seal experiences during respirator use may cause delamination of the mask body layers at the perimeter. Further, such webs can become damaged when exposed to the high temperatures and pressures of molding operations.

### SUMMARY OF THE INVENTION

The present invention provides a filtering face-piece respirator that comprises: a) a harness; b) a mask body that comprises: (i) a filtering structure; (ii) a support structure; and c) a face seal element that has been overmolded onto at least a portion of a perimeter of the support structure of the mask body.

The present invention also provides a process of forming a filtering face-piece respirator. The new process comprises providing a mask body that includes a filtering structure and a support structure where the support structure contains a perimeter member. A face seal element is overmolded onto at least a portion of the perimeter member.

The present invention is beneficial in that it provides an article and process for effectively and economically enabling formation of a filtering face-piece respirator that exhibits enhanced sealing and comfort through attachment of a face seal. The face seal is able to be secured to the mask body without adversely affecting the filter structure at the perimeter. The fibrous nature of filtering structure tends to make it a relatively delicate material, not amendable for being exposed to high pressures and molten plastic, as would occur during an overmolding operation. The present invention can provide a secure, leak-free seal over the support structure members and optionally onto the filtering structure. The overmolding of the face seal to a structural perimeter member provides a very secure bond, which precludes material separation at the perimeter. The strong bond can be achieved without applying adhesives or using welding operations. The overmolded face seal also is beneficial because its shape can be specifically defined through the molding operation, as opposed to being a sheet that is adhesively bonded or welded and that must be conformable to provide a snug fit.

### GLOSSARY

The terms set forth below will have the meanings as defined:

“centerline” means a line that bisects the mask vertically when viewed from the front;

“centrally spaced” means separated from one another along a line or plane that bisects the mask body vertically when viewed from the front;

“chemical bonding”, “chemical adhesion”, “chemically adhered”, and “chemically bonded” refer to physical processes of adhesion responsible for the attractive interactions between atoms and molecules and includes covalent and ionic bonds, as well as hydrogen and van der Waal's bonds and can often depend on available functional groups on a surface to be bonded and their reactivity with the material (e.g., a thermosetting silicone) that is selected to be joined thereto so that pretreatment of the surface to be bonded (e.g., a thermoplastic polymer) is unnecessary;

“conformable” refers to structures that have sufficient flexibility or deformability to be compliant to form contoured, curved, or flat segments in response to forces or pressures from normal use conditions;

“comprises (or comprising)” means its definition as is standard in patent terminology, being an open-ended term that is generally synonymous with “includes”;

“clean air” means a volume of atmospheric ambient air that has been filtered to reduce contaminants;

“contaminants” means particles (including dusts, mists, and fumes) and/or other substances that generally may not be considered to be particles (e.g., organic vapors, et cetera) but which may be suspended in air, including air in an exhale flow stream;

“crosswise dimension” is the dimension that extends laterally across the respirator from side-to-side when the respirator is viewed from the front;

“exterior gas space” means the ambient atmospheric gas space into which exhaled gas enters after passing through and beyond the mask body and/or exhalation valve;

“filtering face-piece” means that the mask body itself is designed to filter air that passes through it; there are no separately identifiable filter cartridges or inserted molded filter elements attached to or molded into the mask body to achieve this purpose;

“filter” or “filtration layer” means one or more layers of air-permeable material, which layer(s) is adapted for the primary purpose of reducing contaminants (such as particles) from an air stream that passes through it;

“filtering structure” means a construction that is designed primarily for filtering air;

“first side” means an area of the mask body that is laterally distanced from a plane that bisects the respirator vertically and that would reside in the region of a wearer's cheek and/or jaw when the respirator is being donned;

“flash” refers to excess material exceeding normal part geometry usually extending as a thin ridge at the interface between the different components forming the cavity of the injection mold tool;

“harness” means a structure or combination of parts that assists in supporting the mask body on a wearer's face;

“injection molding” means making a solid part from liquid plastic that is forced into a mold cavity and cooled;

“insert molding” means an injection molding process whereby plastic is injected into a cavity and around a part that has been placed into the cavity before molding;

“integral” means that the parts are made together at the same time;

“interior gas space” means the space between a mask body and a person's face;

“interpenetration” refers to a process of a liquid material penetrating into voids or spaces in a solid material;

“line of demarcation” means a fold, seam, weld line, bond line, stitch line, hinge line, and/or any combinations thereof;

“juxtaposed” means placed side-by-side but not necessarily in contact with each other;

“mask body” means an air-permeable structure that is designed to fit over the nose and mouth of a person and that helps define an interior gas space separated from an exterior gas space;

“member” in relation to the support structure, means an individually and readily identifiable solid part that is sized to contribute significantly to the overall construction and configuration of the support structure;

“multi-shot molding” refers to molding where material is injected into the cavities of the mold at least twice during a single molding cycle;

“overmolding” means molding one component over or onto another already formed part or component;

“perimeter” means the outer peripheral portion of the mask body, which outer portion would be disposed generally proximate to a wearer's face when the respirator is being donned by a person;

“polymeric” and “plastic” each mean a material that mainly includes one or more polymers and may contain other ingredients as well;

“plurality” means two or more;

“respirator” means an air filtration device that is worn by a person to provide the wearer with clean air to breathe;

“respirator component” means a mechanical part other than the filtering structure or the supporting members of the support structure;

“second side” means an area of the mask body that is distanced from a plane line that bisects the mask vertically (the second side being opposite the first side) and that would reside in the region of a wearer's cheek and/or jaw when the respirator is being donned;

“single-shot molding” refers to molding where material is injected into the cavities of the mold only once during a single molding cycle;

“snug fit” or “fit snugly” means that an essentially air-tight (or substantially leak-free) fit is provided (between the mask body and the wearer's face);

“spaced” means physically separated or having measurable distance therebetween;

“support structure” means a construction that is designed to have sufficient structural integrity to retain the mask in an intended three-dimensional shape and that helps retain the intended shape of the filtering structure supported by it, under normal handling; and

“transversely-extending” means extending generally in the crosswise dimension across the respirator.

### BRIEF DESCRIPTION OF THE DRAWINGS

FIG. 1 is a right-front, partially-broken, perspective view of a filtering face-piece respirator 10 in accordance with the present invention.

FIG. 2 is a rear perspective view of the filtering face-piece respirator 10, showing the face seal element 40 overmolded onto at perimeter portion 20 of the mask body 12 in accordance with the present invention.

FIG. 3 is an enlarged cross-sectional view of the perimeter portion 20, taken along lines 3-3 of FIG. 1.

FIG. 4 is an enlarged schematic and fragmented cross-sectional view, illustrating one embodiment of a filtering structure 18 that may be used in connection with the present invention.

FIG. 5 illustrates a flow diagram 60 of how to make a respirator according to the present invention.

FIG. 6 is perspective view of a preform 72 having an opening 78 for receiving an exhalation valve.

FIG. 7 is a perspective view of a preform 72 having an exhalation valve 38 secured thereto.

FIG. 8 is a perspective view illustrating a nose clip 86 mounted on the upper portion 26 of the perimeter 20 of the mask body 12 before a face seal element has been overmolded thereto.

### DETAILED DESCRIPTION

As will be described, the filtering face-piece respirators may be comprised of a mask body that comprises a filtering structure that can have a three-dimensional configuration, in combination with, a supporting frame structure that has been injection molded to the filtering structure. The words “a”, “an,” and “the” may be used interchangeably with “at least one” to mean one or more of the elements being described. For facilitating the following description and when viewing a filtering face-piece respirator, as projected onto a plane, from the front, a transverse dimension extends across the respirator, and a longitudinal dimension extends between the bottom and the top of the respirator.

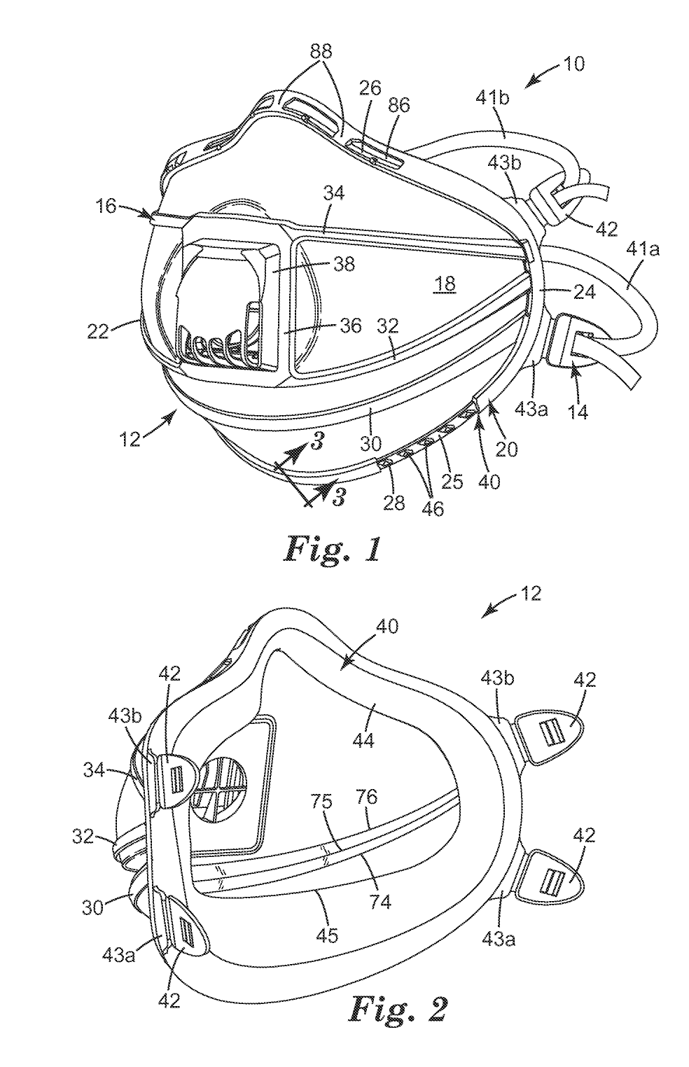

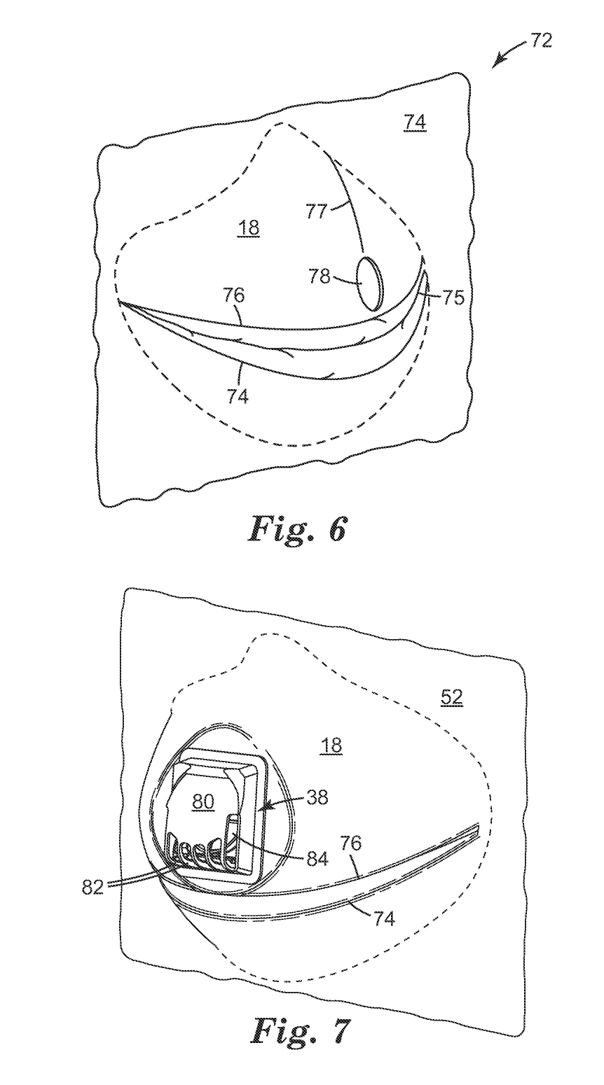

FIG. 1 shows a shaped filtering face-piece respirator 10 that includes a mask body 12 and a harness 14. The mask body 12 includes a support structure 16 and a filtering structure 18. During use, the mask body 12 is worn over the nose and mouth of a person to filter any contaminants that may be present in the ambient air. The particular construction of the mask body 12 may vary according to end use or manufacturing concerns. The support structure 16 may be defined by a three-dimensional shape, such as a generally concave or cup-shaped configuration. The mask body 12 may include a perimeter portion 20 that extends from a first side 22 of the mask body 12 to a second side 24. The perimeter portion 20 may be comprised of a single continuous structural member 25 or may be a combination of members or segments that may extend 360° about the mask body 12. The perimeter portion 20 and the structural member 25 may include, for example, an upper portion 26 and a lower portion 28. The support structure 16 also may comprise a plurality of longitudinally-movable and generally transversely-extending members 30, 32, and 34. One or more of the transversely-extending members may expand or contract longitudinally to better accommodate wearer jaw movement and various sized faces—see U.S. Patent Application Publication 2009/0078261A1 to Martin et al. The transversely-extending members 30 and 32 may, for example, extend from the first side 22 to the second side 24 without being joined together. The members 30 and 32 therefore may move freely relative to one another in the longitudinal dimension. The mask body 12 may readily expand and contract, generally longitudinally, in areas between pairs of the longitudinally-movable and generally transversely-extending members 30, 32, as well as other transversely-extending members that are not joined together by any structural member. The support structure 16 may be comprised of several known materials and may be made by several known techniques. In terms of the materials that may be used, these are described in the published patent application cited above and may include several known plastics, such as olefins including, polyethylene, polypropylene, polybutylene, and polymethyl(pentene); plastomers; thermoplastics; thermoplastic elastomers; thermosets, and blends or combinations thereof may be used. Additives, such as pigments, UV stabilizers, anti-block agents, nucleating agents, fungicides, and bactericides also may be added. The plastic used may exhibit resilience, shape memory, and resistance to flexural fatigue so that the supporting structure may be deformed many times (e.g., greater than 100), particularly at any hinge points, and return to its original condition. The plastic selected may be able to withstand numerous deformations so that the support structure exhibits a greater service life than the filtering structure. The support structure 16 may include a plastic that exhibits a Stiffness in Flexure of about 75 to 300 Mega Pascals (MPa), more typically about 100 to 250 MPa, and still typically about 175 to 225 MPa. Metal or ceramic material may be used in lieu of plastic to construct the support structure 16, although a plastic may be used for disposal/cost reasons. The support structure 16 may be made using any suitable technique including injection molding or other similar approaches. The support structure 16 of the mask body 12 also may include an optional frame member 36 that includes an opening formed therein, which is to be aligned with an opening 78 (FIG. 6) in the filtering structure 18. Such a frame member 36 may provide a location or foundation for securing a valve assembly 38 to the mask body 12. One example of a frame member is described in U.S. Patent Application Publication 2009/0078264A1 to Martin et al. The perimeter portion 20 of the mask body 12 also includes a face seal element 40. The face seal element 40 is overmolded onto the perimeter member 25 of the support structure 16 and also optionally onto the filtering structure 18. The harness 14 may include first strap and second straps 41a and 41b that may be adjustable in length and that may be joined to the mask body 12 through one or more buckles 42. The harness 14 may be secured to the support structure 16 at the first and second sides 22, 24 at harness securement flange members 43a, 43b. The buckles 42 may be secured to the mask body 12 at members 43a, 43b by being integrally molded thereto. Alternatively, the buckles 42 may be insert molded to the support structure at a later point in time or they may be stapled, adhesively bonded, welded, a snap-fitted, heat staked, etc. An example of buckles that may be used in conjunction with the present description is described in U.S. Patent Application Publication 2009/0078266A1 to Stepan.

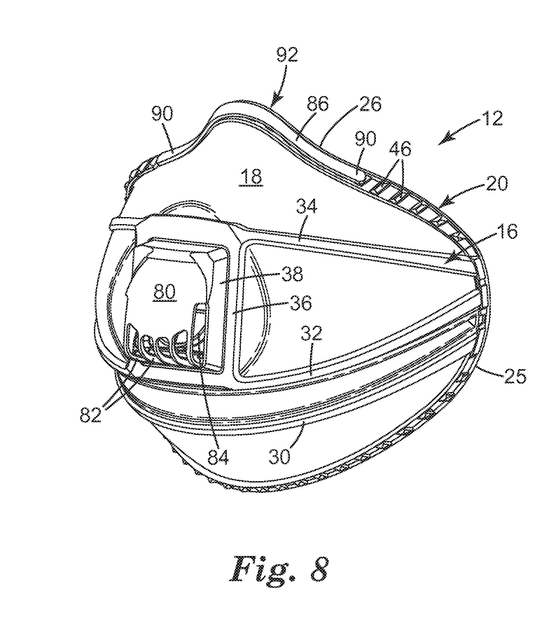

FIG. 2 shows a rear view of the face seal element 40 that is joined to the perimeter member 25 (FIGS. 1 and 8) of the mask body 12 The face seal element 40 provides a comfortable seal against a wearer's face and precludes contaminant influx. When the mask body is properly fitted, the face seal element 40 provides an “air-tight seal” to the wearer's face. The face seal element 40 may be made of various materials and may take on various shapes and sizes depending on the end user and the respirator envisioned. The face seal element 40 is overmolded to a surface of the perimeter member 25 and may be provided with a radially inwardly extending flange portion 44 that is integral thereto. The face seal flange portion 44 is adapted to sealingly engage a wearers' face during respirator use. This may be achieved by providing the flange portion 44 with a molded three-dimensional shape that accommodates the wearer's nose, cheeks, and chin. The face seal flange portion 44 also may be made of a relatively thin plastic material, for example, less than 0.5 millimeters (mm), that can conform to the wearer's face to further provide for a snug fit. One or more “v-shaped” cut outs may be provided along the inside edge 45 of the face seal 40 to facilitate movement of the mask body 12 in the longitudinal direction. The present invention envisions that the overmolding of the face seal 40 may be performed in a step independent of other molding procedures involving other respirator components or generally simultaneously with one or more other respirator components and/or the filtering structure.

FIG. 3 shows a cross-section of the mask body perimeter portion 20 where the face seal 40 is overmolded onto the perimeter member 25 and onto the filtering structure 18. As illustrated, the overmolded face seal essentially surrounds the perimeter structural member 25 so that very little to no portion is visible from the exterior. Incongruities 46 (see also FIGS. 1 and 8) may be provided on the perimeter member 25 to improve the bond thereto. The end 47 of the filtering structure 18, which end 47 is juxtaposed against the perimeter member 25, also is overmolded by the face seal material 40. The filtering structure 18 extends inwardly from the overmolded face seal 40 to provide a fluid-permeable surface area through which air may pass when a wearer inhales. Overmolding to the filtering structure 18 may provide a mechanical connection or interlock to enable several benefits including, among others, a secure interlock or connection, a leak-free engagement, a wider selection of usable materials, little if any surface pretreatment, stronger bonds, and an improved aesthetic appearance. The overmolding may be achieved by molding around the curved generally peripheral member 25 (FIGS. 1 and 8) of the support structure 16. Because of the flexible nature of the structural members and filtering structure, care must be taken when introducing the pressurized liquid plastic forming the face seal element 40. The mold cavity is fashioned to hold the mask body, and accordingly may have a recess that corresponds in shape to the transversely extending members 30, 32, 34 and to the perimeter member 25 and to its incongruities 46. The incongruities 46 may help locate the mask body perimeter member 25 in the mold during the overmolding operation. The incongruities 46 may be fashioned so that only a small tip of the incongruity is visible at the surface of the overmolded face seal. The present invention enables joining of the face seal element 40 to the perimeter member 25 using, for example, chemical bonding, including adhesion arising from the plastic on plastic arrangement. The optional incongruities 46 in the perimeter member 25 of the support structure 16 may include ridges, openings, and pins formed in the perimeter member 25 through which the liquid plastic flows during the overmolding to create an improved bond or mechanical interlock once the liquid plastic is cured to its solid state. The face seal element may be made from a wide variety of materials, including: elastomeric resins such as thermoplastic elastomers (TPE) including block copolymers such as styrene-ethylene-butadiene-styrene (SEBS) and metallocene; silicone; water based acrylics; and blends or combinations thereof. Foamed materials such as ethylene-vinylacetate copolymer (EVA) also may be suitable. The operation of overmolding the face seal element to the support structure may be performed generally simultaneously with the molding of the support structure. Alternatively, the overmolding may happen after the support structure has been molded. The radially-inward extending flange 44 may be molded into a desired face-fitting configuration. It also may be conformable to improve facial contact during respirator use.

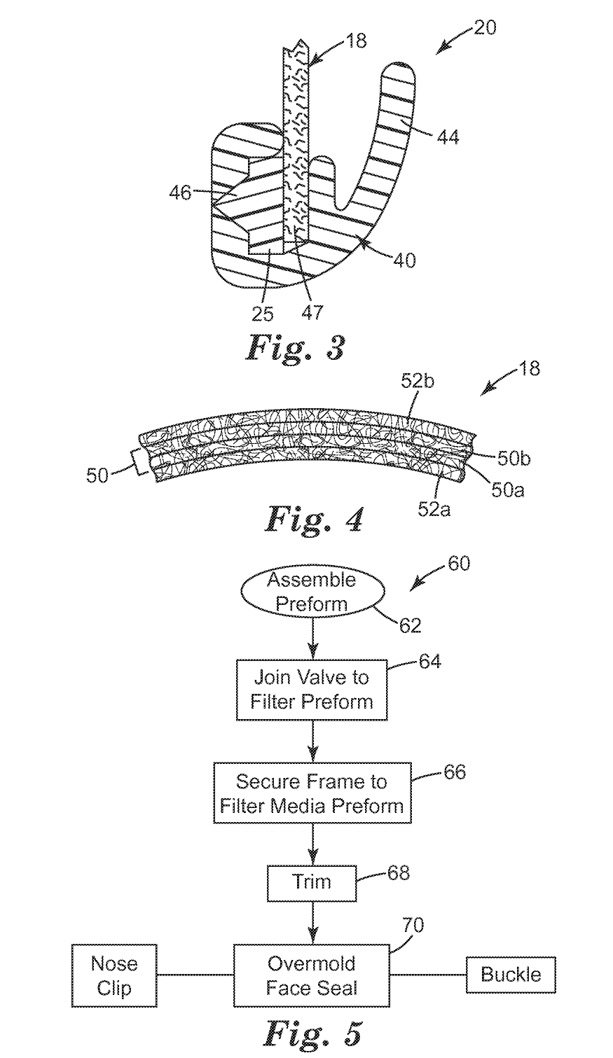

FIG. 4 shows an example of a filtering structure 18 that may be used in conjunction with a mask body of the present invention. Generally, the filtering structure shape corresponds to the general shape of the support structure 16. The filtering structure 18 material(s) may depend upon the kind of contaminants desired to be filtered. Multiple layers of similar or dissimilar filter media may be used to construct the filtering structure. The filtering structure 18 can be a particle capture filter or a gas and vapor filter. The filtering structure 18 also may be a barrier layer that prevents liquid transfer from one side of the filter layer to another to prevent, for instance, liquid aerosols or liquid splashes from penetrating the filter layer. Filtering structures that may be beneficially employed in a layered mask body of the present invention are generally low in pressure drop (for example, less than about 200 to 300 Pascals at a face velocity of 13.8 centimeters per second) to minimize the breathing work of the mask wearer. Filtration layers additionally are flexible and have sufficient shear strength so that they generally retain their structure under expected use conditions. The filtering structure 18 typically is adapted so that it properly fits against or within the support structure. The filtering structure 18 may be disposed inwardly from the support structure, it may be disposed outwardly of the support structure, or it may be disposed between various members that comprise the support structure. The filtering structure 18 may include one or more filtration layers, for example, a pair of filtration layers 50a,b (collectively, 50) and also inner and outer cover webs 52a, 52b (collectively, 52), respectively. The filtering structure 18 also may use a pre-filter of which the cover web 52 may satisfy. The filtering structure may include materials, such as sorptive materials including activated carbon disposed between the fibers and/or various layers that comprise the filtering structure—see, for example, U.S. Pat. Nos. 6,234,171 and 6,102,039 to Springett et al. The filtering structure may include more than one filtration layer and may be used in conjunction with sorptive layers to provide filtration for both particulates and vapors. Examples of particle capture filters include one or more webs of fine inorganic fibers (such as fiberglass) or polymeric synthetic fibers. Synthetic fiber webs may include electrically charged (electret) polymeric microfibers that are produced from processes such as meltblowing. Polyolefin microfibers formed from polypropylene that has been electrically charged provide particular utility for particulate capture applications. An alternate filter layer may comprise a sorbent component for removing hazardous or odorous gases from the breathing air. Sorbents may include powders or granules that are bound in a filter layer by adhesives, binders, or fibrous structures—see U.S. Pat. No. 3,971,373 to Braun. A sorbent layer can be formed by coating a substrate, such as fibrous or reticulated foam, to form a thin coherent layer. Sorbent materials may include activated carbons that are chemically treated or not, porous alumna-silica catalyst substrates, and alumna particles. An example of a sorptive filtration structure that may be conformed into various configurations is described in U.S. Pat. No. 6,391,429 to Senkus et al.—see also U.S. Patent Application Publication 2006/0254427A1 to Trend et al.

The filtration layer(s) may come in a variety of shapes and forms. Typically, the filtration layer(s) each may have a thickness of about 0.2 millimeters (mm) to 1 centimeter (cm), more typically about 0.3 mm to 0.5 cm. The filtration layer may be a generally planar web or it may be corrugated to provide an expanded surface area—see, for example, U.S. Pat. Nos. 5,804,295 and 5,656,368 to Braun et al. and U.S. Pat. No. 6,858,297 to Shah et al. The filtration layer(s) also may include multiple filtration layers joined together by an adhesive or any other means—see U.S. Pat. No. 6,923,182 to Angadjivand et al. Webs of melt-blown fibers, such as those taught in Wente, Van A., Superfine Thermoplastic Fibers, 48 Indus. Engn. Chem., 1342 et seq. (1956), especially when in a persistent electrically charged (electret) form are especially useful (see, for example, U.S. Pat. No. 4,215,682 to Kubik et al.) These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. BMF webs that contain fibers formed from polypropylene, poly(4-methyl-1-pentene), and combinations and blends thereof, are particularly suitable. Electrically charged fibrillated-film fibers as taught in van Turnhout, U.S. Pat. Re. 31,285 may also be suitable, as well as rosin-wool fibrous webs and webs of glass fibers or solution-blown, or electrostatically sprayed fibers, especially in microfilm form. Electric charge can be imparted to the fibers by contacting the fibers with water as disclosed in U.S. Pat. Nos. 6,824,718, 6,454,986 and 6,406,657 to Eitzman et al., 6,783,574, 6,375,886, and 5,496,507 to Angadjivand et al., and 6,743,464 to Insley et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment—see U.S. Pat. Nos. 6,398,847, 6,397,458, and 6,409,806 to Jones et al. Typical basis weights for electret BMF filtration layers are about 10 to 100 grams per square meter.

The inner cover web 52a can be used to provide a smooth surface for contacting the wearer's face, and the outer cover web 52b can be used to entrap loose fibers in the mask body or for aesthetic reasons. The cover webs 52 typically do not provide any substantial filtering benefits to the filtering structure, although it can act as a pre-filter when disposed on the exterior (or upstream to) the filtration layer. To obtain a suitable degree of comfort, the inner cover web may have a comparatively low basis weight and may be formed from comparatively fine fibers. More particularly, the cover webs may be fashioned to have a basis weight of about 5 to 50 g/m² (typically 10 to 30 g/m²), and the fibers may be less than 3.5 denier (typically less than 2 denier, and more typically less than 1 denier but greater than 0.1). Fibers used in the inner cover web often have an average fiber diameter of about 5 to 25 micrometers, typically of about 7 to 20 micrometers, and more typically of about 8 to 12 micrometers. The inner cover web material may have a degree of elasticity (typically, but not necessarily, 100 to 200% at break) and may be plastically deformable. Suitable materials for the cover web are blown microfiber (BMF) materials, particularly polyolefin BMF materials, for example polypropylene BMF materials (including polypropylene blends and also blends of polypropylene and polyethylene). A suitable process for producing BMF materials for a cover web is described in U.S. Pat. No. 4,013,816 to Sabee et al. The cover web may be formed by collecting the fibers on a smooth surface, typically a smooth-surfaced drum. Spun-bond fibers also may be used.

Typical cover web(s) may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material after ultrasonic welding. Polyolefin materials that are suitable for use in a cover web may include, for example, a single polypropylene, blends of two polypropylenes, and blends of polypropylene and polyethylene, blends of polypropylene and poly (4-methyl-1-pentene), and/or blends of polypropylene and polybutylene. One example of a fiber for the outer cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Fibers used in the outer cover web often have an average fiber diameter of about 5 to 24 micrometers, typically of about 7 to 18 micrometers, and more typically of about 8 to 12 micrometers. The average fiber diameter may vary depending on the materials used. Another suitable fiber is a polypropylene/polyethylene BMF (produced from a mixture comprising 85 percent of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available, under the trade designations “Corosoft Plus 20”, “Corosoft Classic 20” and “Corovin PP-S-14”, from Corovin GmbH of Peine, Germany, and a carded polypropylene/viscose material available, under the trade designation “370/15”, from J.W. Suominen OY of Nakila, Finland. The cover webs may have very few fibers protruding from the cover web surface after processing and therefore may exhibit a smooth outer surface. Examples of cover webs that may be used in the present invention are disclosed, for example, in U.S. Pat. No. 6,041,782 to Angadjivand, U.S. Pat. No. 6,123,077 to Bostock et al., and WO 96/28216A to Bostock et al.

FIG. 5 illustrates the steps 60 that may be used to manufacture a respirator of the present invention. As shown, a preform is first provided 62 onto which an optional exhalation valve may be joined 64. The support frame is then joined 66 to the preform, and excess preform material is trimmed 68 to create a mask body having a support structure and a filtering structure. The face seal is then overmolded 70 onto the support structure perimeter and onto the filtering structure if desired. In step 64, the exhalation valve is joined to the filter media or filtration structure preform. The filter media or filtration structure preform may be made of the filtering structure materials/layers described above. As shown in FIG. 6, the preform 72 may include a blank of filtration material, the shape of which may vary depending on the kind of respirator intended to be made. The preform blank 72, after being dispensed from a typical preform blank roll, may be cut into an untrimmed article that exceeds the size of the respirator. In the preform 72 the solid lines 74, 76, 77 represent weld lines that contribute to the structural shape and integrity of the filtering structure to help form and maintain a cup-shaped configuration. The filtering structure 18 may include first and second transversely-extending lines of demarcation 74 and 76 generally oriented as depicted. The lines of demarcation 74, 76, may be comprised of a fold, a weld line, a stitch line, a bond line, a hinge line, or combinations thereof. Generally, the first and second lines of demarcation 74 and 76 correspond to the location of certain transversely-extending members on the support structure. The first and second lines of demarcation 74, 76 define a pleat line 75 that may be formed therebetween. The first and second lines of demarcation 74, 76 may be secured to longitudinally-movable, transversely-extending members 30 and 32 (FIGS. 1 and 8), thereby allowing the filtering structure 18 to open and close in an accordion-like manner about the pleat 75. A vertical line of demarcation 77 may be employed to eliminate excess material that would otherwise accumulate in the nose region during the manufacturing process. A similar generally vertical line of demarcation (not shown) also may be included at the chin portion of the filtering structure 18. Although the filtering structure 18 has been illustrated with only two transversely-extending lines of demarcation 74 and 76 to define a single pleat 75, the filtering structure 18 may include two or more pleats in the cross-wise dimension. Generally, the shape of the filtering structure 18 may correspond to the general shape of the support structure. The preform 72 may be formed with a generally centrally disposed opening 78 in the filtering structure 18 for suitable cooperation with a valve assembly that is secured to the filtering structure. As shown in FIG. 7, an exhalation valve 38 is joined to the untrimmed preform blank 72 in step 64 at the location of an opening 78 in the preform. The exhalation valve 38 may be adhesively bonded, welded, mechanically clamped, or otherwise suitably connected to the filtering structure of the blank—see U.S. Pat. Nos. 7,069,931, 7,007,695, and 6,959,709 to Curran et al. for methods of securing an exhalation valve to a mask body. Exhalation valves generally operate to rapidly purge the wearer's exhaled air from the mask interior, thereby improving wearer comfort. The exhalation valve 38 also includes a valve cover 80 that resides over a valve seat to define an air chamber through which exhaled air passes before exiting the valve at the valve cover opening(s) 82. The exhalation valve 38 has a flexible flap 84 that lifts from the valve seat in response to exhalation pressure generated by a wearer during exhalation. Examples of suitable exhalation valves are described in U.S. Pat. Nos. 7,493,900, 7,428,903, and 7,311,104 to Japuntich et al. and in 7,188,622 and 7,028,689 to Martin et al.

In step 66, the support structure is joined to the filtering structure preform blank. Injection molding may be used to secure the support structure to the filtering structure—see U.S. patent application Ser. No. ______, entitled Filtering Face-Piece Respirator Having Support Structure Injection Molded to Filtering Structure, filed on the same day as this patent application (attorney case number 64756US002). The injection molding may be performed to achieve a bonding of the support structure members to melted and partially melted fabric of the cover web and filtration layer(s) and some form of mechanical interpenetration to the fibers of the cover web filtration layer. This type of bonding may include a mechanical interlock or connection to provide a relatively and strong joint having enhanced durability and improved aesthetics. The filtering structure with the optional exhalation valve secured thereto can be placed on the core of a first horizontal mold half in a vertical press. Appropriate registration between the first mold core and the filtering structure and exhalation valve may be achieved using known alignment systems. The filtering structure and exhalation valve may be retained using gravity, ridges, and retaining reference features on the valve. A second half has a cavity that has a shape and size that is a negative of the shape of the combined filtering structure, support structure, and exhalation valve may be closed upon the first half. Following registration, liquid plastic is injected into the second mold cavity in an injection pressure range and in a temperature range and for a timing cycle to bring about the desired mechanical interpenetration of the plastic of the support structure to the permeable structure of filtering structure. The materials of the support structure and the filtering structure as well as other components may be the same or may be dissimilar. The temperatures, injection pressures, and curing times selected for molding vary and depend, in part, on the materials to be insert molded together. The injection pressure range may vary from about at least 50 tons, and more typically, from about 60 Tons to about 140 tons, for a vertical pressure mold, while the temperature of the liquid plastic will vary on the plastic material being used to form the support structure 16. The timing cycle will vary depending on the materials being combined as illustrated in the above examples.

In step 68, the untrimmed portion of the preform blank 74 (FIG. 6) extending beyond the perimeter of the support structure may be cut by a trimming device, such as that is commercially available from Air-Hydraulics, Inc., Jackson, Mich. A blade trimming device may cut or trim the overhanging portion of the filtering structure perimeter that extends laterally beyond the perimeter member of the supporting structure. In addition to the untrimmed portion of the preform blank, excess plastic on the support structure too may be removed. Such excess plastic may result from means to facilitate or improve flow of material to the support structure during step 66. Other techniques may be used to trim the excess material, including lasers, hot wires and other suitable devices.

In step 70, a face seal element 40 (FIGS. 1-3) may be overmolded to the periphery of the support structure. The face seal may be secured to the mask body using single or multi-shot molding. Once the supporting frame has been injection molded onto the filtering structure, then, without removing the molded part, the mold may be opened slightly to allow for a second injection of the polymeric material used to overmold the face seal. In one instance, this can be achieved when all the desired components are appropriately placed in the molding device. Care should be exercised for ensuring that the perimeter portion of the filtering structure retains its location in the mold during the injection molding because of the pressurized plastic being applied. As shown in FIG. 8, a nose clip 86 may be positioned onto the support structure before the overmolding of the face seal. The nose clip may be mounted in a cavity for holding the nose clip and may be overmolded when the face seal element is molded onto the support structure. To obtain such a positioning of the nose clip 86, the clip is inserted into a mold cavity of a vertical molding apparatus. The nose clip end portions face upwardly when mounted in the lower mold cavity. The nose clip 86 may be placed into a lower mold cavity so that it will be retainable over the protuberances and be located between terminal ends of the ridges 46 on the perimeter member. The mask body 12 when lowered into such lower mold cavity rests upon the nose clip 86.

During use, the nose clip can be typically deformed into its desired shape to provide a proper fit over the bridge of a wearer's nose and against the wearer's face beneath each of the wearer's eyes. The polymeric material that is used in the support structure and the face seal element may be the same or similar as well as may be different depending on, for example, the process of making as will described below. Because the nose clip is made from a manually-malleable, deformable material, the nose clip is able to maintain its shape, after it has been deformed into its desired shape by the respirator wearer. The nose clip may be made of a suitable dead soft metal such as aluminum. The bonding between the nose clip and the plastic may be mechanical or by adhesion, or by combinations thereof. The mechanical bonding can occur by, for example, shrinking the resin of the face seal element around the nose clip insert in its entirety or at intermediate locations 88 and at clip ends 90 (FIG. 1). Mechanical bonding may be enhanced also by providing the nose clip 72 with irregularities, e.g., a roughened or coarse pattern on its surface. To adequately secure the nose clip to the nose portion 92 of the support structure 16, the molding may be performed using standard molding, casting, or other suitable equipment. The nose clip is loaded in and properly retained into the desired location or insert position within the mold cavity. Rotary or shuttle-type equipment may be used for this purpose to enable the equipment and/or operators to load and unload nose clip inserts into the desired mold location. The nose clip may be mounted as illustrated in FIG. 1, where end portions of the nose clip are embedded in the support structure and/or face seal.

### Examples

### A. Forming Respirator Filtering Structure

A respirator filtering structure was formed from two 254 millimeter (mm) wide laminated layers of standard 3M 8511 N 95 respirator electret filter material between a (50 grams per square meter (gsm)) white nonwoven spunbond outer layer and an inner (22 gsm) white nonwoven spunbond material. Both layers comprised polypropylene. The laminated web was cut in to 254 mm long pieces before forming the three-dimensional pleat and cup formation. The complex 3D pleat was formed by ultrasonically welding two curves of the same 258.5 mm radius. The distance between the highest points on each curve was 40.0 mm, and the two ends of the curves met at left and right points, which were 202 millimeters (mm) apart. The first curve was formed by folding the laminated filter media along a first fold line at 76 mm away from one from one end of laminated web. The second curve was formed by welding along the secondary curve line by folding the laminated web at a secondary fold line 62 mm away from the first fold line. Once the two curves that make the 3D pleat were formed, excess material outside of the curve lines was removed. Then the material was then folded along the vertical center line and a third weld curve was welded, starting at 51 mm away from the center of the second curve line. This removed any excess material and helped form a cup that fits in the respirator support structure design. An ultrasonic welding process was used to fashion the filtering structure. A central opening was provided in the filtering structure using ultrasonic welding to weld and cut out the opening. The resulting filtering structure resembled the structure shown in FIG. 6.

### B. Forming Respirator Support Structure

Samples of respirator supporting structure were overmolded onto the filtering structure using a standard injection molding process. A single cavity mold that had male and female halves was formed which matched the geometry of supporting structure shown in FIGS. 1 and 8. The mold configurations allowed the filtering structure to be placed over the male part of the mold and be held in place before molding. The mold design also included a clearance between the male and female parts of the mold to compensate for the thickness of filtering structure.

Injection molding of the support structure was done using a 154 ton FN 3000 NISSEI Injection Molding Press (commercially available from Nissei America, Inc., Anaheim, Calif.). using process conditions listed in Table 1 below. Four different prototypes were made with the following resin materials:
100% Monoprene 1249D from Teknor Apex, Pawtucket, R.I.,
50% Monoprene 1249D and 50% Monoprene 1337A from Teknor Apex, Pawtucket, R.I.,
50% Elastocon 2825 and 50% Elastocon 2810 from Elastocon TPE Technologies, Rochester, Ill.,
100% Polypropylene 7823 from Total Petochemicals, USA, Inc., Houston Tex.
   After molding at a relaxed state or while the support structure was still on the mold, the support structure measured 115 mm top to bottom and 120 mm from side to side. The targeted thickness of the support structure members was 2.5 millimeters.

TABLE 1
Support Structure Molding Process Conditions

| | Materials | | | |
|---|---|---|---|---|
| | | 50% MP- | 50% Elastocon | |
| Process | 100% | 1249D, 50% | 2825/50% | 100% |
| Condition | MP-1249D | MP-1337A | Elastocon 2810 | PP7823 |
| Cycle time(s)^{a} | 35 | 32 | 36 | 32 |
| Injection time(s) | 11 | 9 | 13 | 8.3 |
| Fill Time(s) | 3 | 3 | 3 | 3 |
| Cooling Time(s) | 20 | 20 | 20 | 20 |
| Injection | 115 | 123 | 62 | 139 |
| Pressure (tons) | | | | |
| Barrel | 210 | 210 | 210 | 210 |
| temperature^{b(° C.)} | | | | |

^{a}not including placing filtering element in to mold
^{b}nozzle, front, center and rear

### C. Overmolding Face Seal

Samples of respirator face seal were overmolded onto the filtering face-piece respirator support structure using a standard injection molding process. Single cavity male and female halves were formed which matched the geometry of face seal structure shown in FIGS. 1 and 2. The mold configurations allowed the mask body to be placed into the female part of the mold and be held in place before molding. Prior to inserting the mask body in to the mold, a nose clip was placed into a cavity in the female half side of the mold.

Injection molding of the face seal was done using a 150 ton FN 3000 NISSEI Injection Molding Press, that is commercially available from Nissei America, Inc., Anaheim, Calif. The samples were made of 97% 1249D Monoprene from Teknor Apex, Thermoplastic Elastomeric division, 3070 Ohio Drive, Henderson, Ky. 42420. A 3% Panthon 283C light blue pigment OM53642471 from Clariant USA 4000 Monroe Road, Charlotte, N.C. 28205 was added to give the produce a desired color. The thickness of the face seal flanges was within the range of 0.7 to 0.75 mm.

The molding process conditions for making the samples were:
Barrel temperature 215 degree centigrade
Injection time of 3.0 seconds(S), fill time 0.78 S, injection pack time 1.0 S, hold time 5.0 S, and cooling time of 20
Overall cycle time including placing nose clip and filtering element into the mold was 65 seconds
Injection pressure 8960 kilonewton/square meter

The resulting product had the face seal secured to the perimeter member of the support structure and onto the filtering structure along its periphery. The resulting bond was very secure and airtight.

This present description may take on various modifications and alterations without departing from the spirit and scope. Accordingly, this present description is not limited to the above-described embodiments but is to be controlled by limitations set forth in the following claims and any equivalents thereof. This present description also may be suitably practiced in the absence of any element not specifically disclosed herein. All patents and publications noted above, including any in the Background section are incorporated by reference into this document in total.

What is claimed is:

1. A filtering face-piece respirator that comprises:
a) a harness;
b) a mask body that comprises:
(i) a filtering structure;
(ii) a support structure; and
c) a face seal element that has been overmolded onto at least a portion of a perimeter of the support structure of the mask body.

2. The filtering face-piece respirator of claim 1, wherein the overmolded perimeter of the support structure includes incongruities.

3. The filtering face-piece respirator of claim 1, further including a respirator component that is held in place at least in part by the face seal element that has been overmolded onto the perimeter of the mask body support structure.

4. The filtering face-piece respirator of claim 3, wherein the at least one respirator component comprises a nose clip.

5. The filtering face-piece respirator of claim 1, wherein the face seal element is also overmolded onto a periphery of the filtering structure.

6. The filtering face-piece respirator of claim 5, wherein the filtering structure is juxtaposed against the support structure where the face seal element is overmolded onto the filtering structure.

7. The filtering face-piece respirator of claim 1, wherein the face seal element comprises a radially inwardly extending flange that has been molded into a three-dimensional configuration.

8. The filtering face-piece respirator of claim 7, wherein the face seal flange portion is made of a plastic material that is less than about 0.5 millimeters thick which can conform to the wearer's face during use.

9. The filtering face-piece respirator of claim 1, wherein the face seal element is overmolded onto the perimeter structural member such that little to no portion of the perimeter structural member is visible from the exterior.

10. The filtering face-piece respirator of claim 1, wherein the face seal element is secured to the perimeter member comprising chemical bonding.

11. The filtering face-piece respirator of claim 1, wherein the face seal element comprises a thermoplastic elastomer selected from the group consisting of SEBS, metallocene, and combinations thereof.

12. A process for making a filtering face-piece respirator, the process comprising:
providing a mask body that comprises a filtering structure and a support structure, the support structure including a perimeter member; and
overmolding a face seal element onto at least a portion of the perimeter member.

13. The process of claim 12, wherein the support structure has been molded to the filtering structure prior to the overmolding of the face seal.

14. The process of claim 12, wherein the overmolding of the face seal element is carried out generally simultaneously with the molding of the filtering structure.

15. The respirator of claim 12, wherein a preform is first provided onto which a support structure is then joined.

16. The process of claim 15, wherein the face seal element is overmolded onto the perimeter of the support structure after the support structure is joined to the preform.

17. The process of claim 13, wherein the preform is trimmed after the support structure molding step.

18. A filtering face-piece respirator that comprises:
a) a harness that comprises one or more straps;
b) a mask body that comprises:
(i) a filtering structure that includes one or more layers of filter media and at least one cover web;
(ii) a support structure that includes a perimeter member and at least one member that extends across the mask body; and
c) a face seal element that has been overmolded onto at least a portion of the perimeter member and a portion of the filtering structure.
